(19) United States
(12) Patent Application Publication
(10) Pub. No.: US 2008/0245391 A1
(43) Pub. Date: Oct. 9, 2008

(54) System and method for wiping a windshield

(76) Inventors: Jim Wulf, Morris, IL (US); Gary Williams, Braidwood, IL (US)

Correspondence Address: Law Office of Martin E. Jerisat, Suite 3300, 10 S. LaSalle Street, Chicago, IL, 60603, US

(21) Appl. No.: 12/080,475

(22) Filed: Apr. 3, 2008

Related U.S. Application Data
(60) Provisional application No. 60/922,292, filed on Apr. 6, 2007.

(51) Int. Cl. B60S 1/30; B08B 1/00

(52) U.S. Cl. 134/6; 15/250.28

(57) ABSTRACT

A system and a method for wiping a windshield are provided here. The system may include a first elongated member and a second elongated member. Both members are coupled to each other. The distance between the members may be adjusted to sandwich the windshield between them. The system may be adjusted to fit the design of any windshield. The method includes the steps of placing the first member and second members across opposing sides of the windshield, and adjusting the distance between them according to the design and dimensions of the windshield.

### BACKGROUND OF THE INVENTION

The present invention generally relates to a system and a method for wiping a windshield, such as the windshield of a motorcycle. The typical windshield of a motorcycle is curved and has inside surface and an outside surface.

When riding a motorcycle in the rain, both sides of the windshield get wet over time thereby blocking the vision of the rider. The visibility problem sometimes gets worse when the rain blows over the top of the windshield and runs down the inside surface.

The prior art includes a mechanical wiper mounted on the motorcycle's windshields. The mechanical wiper has many disadvantages. The wiring, blades and motor may block the vision of the rider. Even if the wiper is mounted to the side, the wiring and blade may still block the vision of the rider because the wiper must be designed to be long enough to reach the top of the windshield. Another problem is that the constant motion of a mechanical wiper may scratch the windshield, which is typically made of plastic polymers.

Additionally, there are no standard designs for motorcycle windshield, which makes it difficult to design a mechanical wiper that fits all motorcycles' windshields. Every manufacturer has its own standard dimensions, height, width, thickness, curvatures and so forth. Different motorcycles' windshields made by the same manufacturer may even have different dimensions and designs.

Accordingly, there is a need for a system for wiping a windshield that can be easily adapted for use with any motorcycle. There is also a need for a wiper that does not block the vision of the rider and allows for quick cleaning of the windshield while riding the motorcycle in the rain.

### SUMMARY OF THE INVENTION

The objects mentioned above, as well as other objects, are solved by the present invention, which overcomes disadvantages while providing new advantages not previously obtainable in the prior art.

In a preferred embodiment, a system and a method for wiping a windshield are provided. The windshield typically has a certain curvature and thickness. The windshield defines a concave inside surface and convex outside surfaces. The dimensions and designs of motorcycles' windshields vary depending on the manufacturer and the type of the motorcycle.

The system for wiping a windshield according to the principles of the invention may comprises a pair of elongated members, a first and a second members. The first elongated member may engage the inside surface of the windshield. The first elongated member may have an upper surface and a bottom surface. The first member may include a rubber blade that may be mounted on the upper surface to clean the inside surface. The first member may also include a handle to enable the motorcycle rider to grab the handle and swipe the windshield.

The second elongated member may be positioned opposite the first member. The second member may engage the outside surface of the windshield. The second member may include an upper surface and a bottom surface. A rubber blade may be mounted on the upper surface to clean the outside surface of the windshield.

The first and second members may be coupled to each other to make the system adjustable to accommodate various curvatures and designs of motorcycles' windshields. The first and second members may be moveable between a first position where the members are separated by an initial distance and a second position where the members are separated by a final distance.

The initial distance may be different from the final distance. This flexibility allows the user to vary the tension between the blades and the windshield according to the specific curvature and thickness of each particular windshield. This flexibility also enables the user to swipe any portion of the windshield by simply moving the system across the windshield. This flexibility also allows the user to put the system away and store it in the saddle area, for example, if desired.

An alternative embodiment includes a method for wiping a windshield. The method may include the steps of placing the first elongated member across the inside surface of the windshield. The first elongated member may include an upper surface and a bottom surface. The method also includes the step of placing the second elongated member across the outside surface of the windshield. The second elongated member may be positioned opposite to the first member. The second elongated member may include an upper surface and a bottom surface. The second member may be coupled to the first member and the first and second members are separated by an initial distance. The method also includes the step of adjusting the initial distance between the first and second members to sandwich the windshield between them to enable the members to clean the windshield properly and efficiently.

A further embodiment may include a system for wiping a curved windshield, which has an inside and outside surfaces. The system may include means for wiping the outside surface of the windshield, means for wiping the inside surface of the windshield, and means for adjusting the distance between the means for wiping the outside surface and the means for wiping the inside surface to sandwich the windshield between them.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 shows a preferred embodiment of the present invention engaging a motorcycle's windshield;

FIG. 2 is a top view showing a preferred embodiment in an initial position;

FIG. 3 is a top view showing the preferred embodiment of FIG. 2 in a second position;

FIG. 4 is a side view of the preferred embodiment;

FIG. 5 shows a top view of an alternative embodiment;

FIG. 6 shows a side view of the alternative embodiment of FIG. 5;

FIG. 7 shows a further embodiment according to the principles of the present invention;

FIG. 8 shows another alternative embodiment; and

FIG. 9 shows another alternative embodiment.

### DETAILED DESCRIPTION OF PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

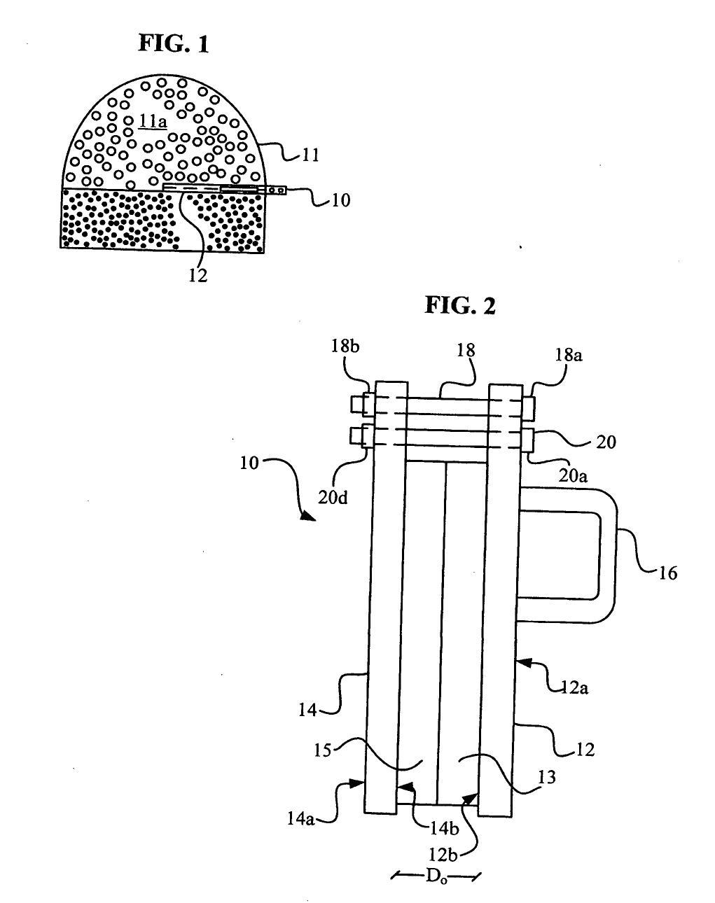

FIG. 1 shows a preferred embodiment of the present invention system 10 engaging motorcycle's windshield 11. Windshield 11 has an arcuate inside surface 11a, and an arcuate outside surface 11b (not shown). Motorcycles' windshields come in a variety of designs and dimensions. The system 10 of the present invention may be easily adapted to fit any design. System 10 may be designed to be releasably engaging windshield 11. System 10 may be disengaged from windshield 11 and stored in a nearby place, like the saddlebag, for example. System 10 may include two elongated members, a first member 12 and a second member 14 (shown in FIG. 2). First elongated member 12 may engage inside surface 11a while second member 14 may engage outside surface 11b.

FIG. 2 shows a top view of system 10 in an initial position. First longitudinal member 12 of system 10 may include a bottom surface 12a and an upper surface 12b. Second longitudinal member 14 of system 10, may include a bottom surface 14a and an upper surface 14b.

First elongated member 12 may also include a vertically extending member, such as blade 13 for engaging and cleaning inside surface 11a. Blade 13 may be mounted on the upper surface 12b of first elongated member 12. First elongated member 12 may include a handle 16 for receiving a user's grip to manipulate system 10. Second elongated member 14 may include a vertically extending member, such as blade 15 for engaging and cleaning outside surface 11b of windshield 11. Blade 15 may be mounted on the upper surface 14b of second elongated member 14.

First longitudinal member 12 may be coupled to second longitudinal member 14 by a variety of fasteners and attachments, such as fastener 18 and/or fastener 20. Fastener 18 may be an adjustable screw that has a screw head 18a and lock nut 18d. Fastener 20 may include a variety of connectors known in the art. For example, fastener 20 may be an adjustable screw that has screw head 20a and a lock nut 20d.

First elongated member 12 may be adjustably separated from second elongated member 14 by an initial distance, D0. The distance D0 may be adjustable by selectively tightening or releasing adjustable screws 18 and/or 20 so that windshield 11 may be sandwiched between blades 13 and 15 with enough tension to enable a user to wipe inside and outside surfaces 11a and 11b.

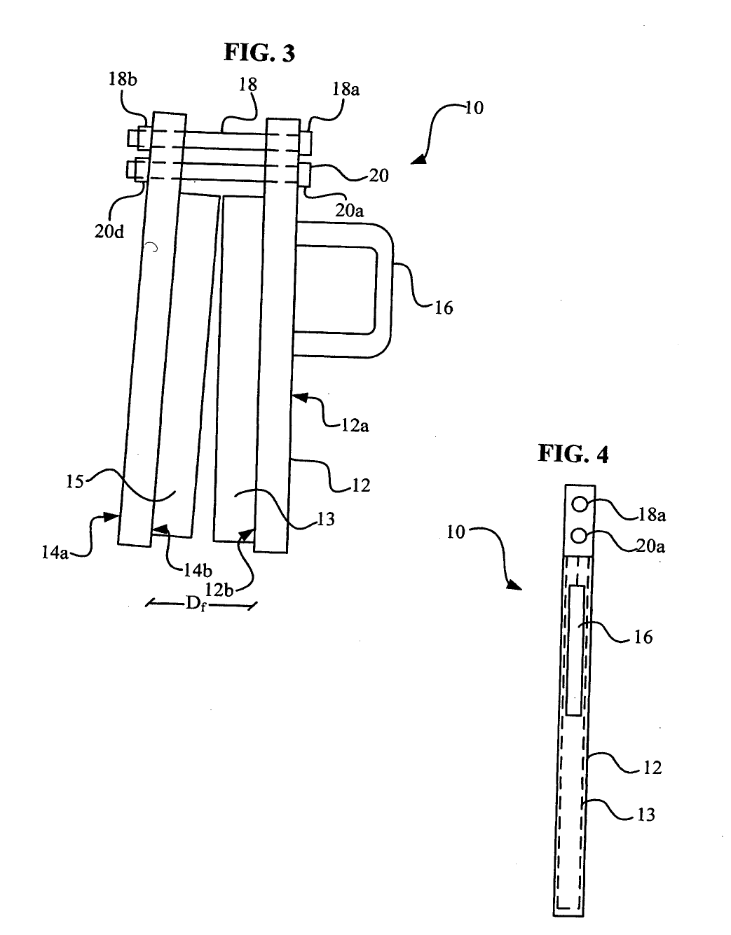

FIG. 3 shows system 10 in a second position where first member 12 and second member 14 are separated by a distance Df, which is different from distance D0. A user may easily adjust the distance between members 12 and 14 by simply adjusting connectors 18 and/or 20 according to the width and curvature of windshield 11. System 10 may be adjusted to fit any windshield design and dimensions by varying the distance between members 12 and 14.

System 10 is a manual apparatus that may easily be stored in a saddlebag area for future use, for example. A user may also place system 10 on the bottom of windshield 11 in a horizontal resting position, as previously shown in FIG. 1. During the rain, a user may swipe system 10 from one side of windshield 11 to the other side to clean any moisture or residue. The tension between blades 13 and 15 and windshield 11 may allow system 10 to hold on windshield 11 by itself.

System 10 may be made of any materials, such as wood, aluminum, steel, plastic, hard rubber or any other materials. Blades 13 and 15 may be adjustable or non adjustable. Blades 13 and 15 may be made of rubber, sponge or any other materials.

System 10 may be made of one piece molded plastic, which may include handle 16, with two rubber blades 13 and 15 attached to members 12 and 14 respectively. System 10 may be made in various lengths to accommodate different sizes of windshield 10 if necessary. System 10 may be made in any shape or size.

FIG. 4 is a side view of a preferred embodiment of system 10 showing first elongated member 12. First elongated member 12 is shown including vertically extending member, blade 13, and handle 16. First elongated member 12 may be coupled to second elongated member 14 by a variety of connectors, such as adjustable screws 18 and 20, previously shown in FIG. 3. Screws heads 18a and 20a are shown in this figure.

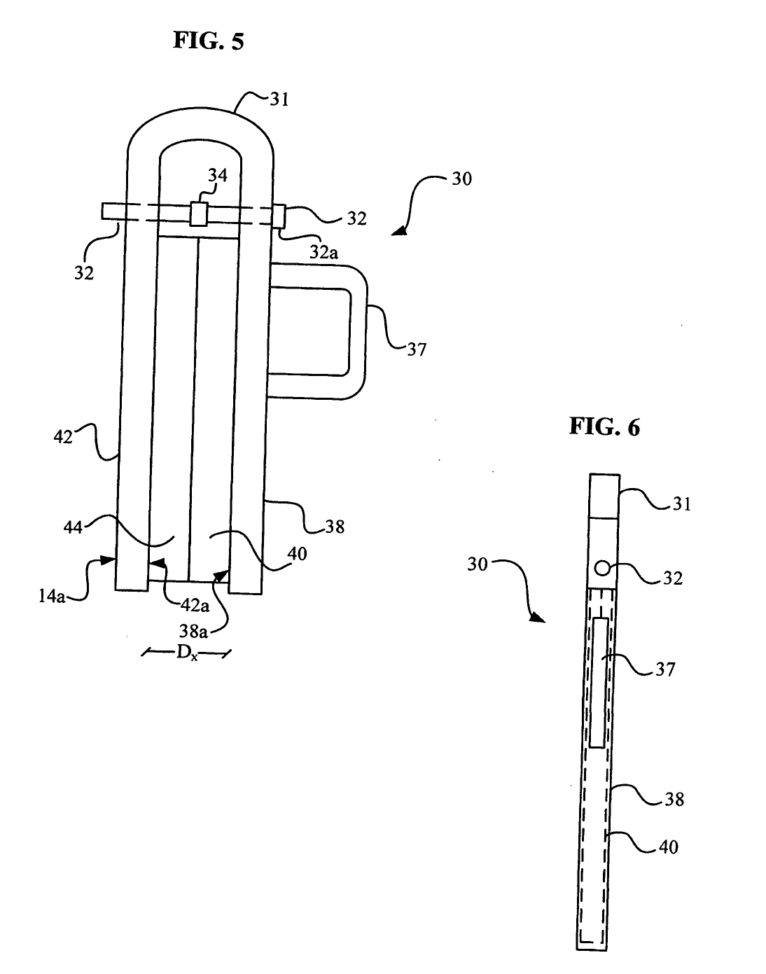

FIG. 5. shows a top view of an alternative embodiment system 30. System 30 may include a first elongated member 38 and a second elongated member 42. First member 38 may include a vertically extending member, such as cleaning blade 40, which may be mounted on the upper surface 38a. First member 38 may also include a handle 37 for receiving a user's grip. Second member 42 may include a vertically extending member, such as cleaning blade 44, which may be mounted on the upper surface 42a.

First and second elongated members 38 and 42 may be coupled by a third member 31, and may be separated by distance Dx. Members 38 and 42 are selectively and adjustably connected by an adjustable fastener, such as screw 32, with adjustable wheel 34 to enable a user to vary distance Dx to hold any windshield 10 sandwiched between blades 40 and 44.

FIG. 6 shows a side view of system 30 showing first member 38 having a handle 37 for receiving a user's grip and a blade 40.

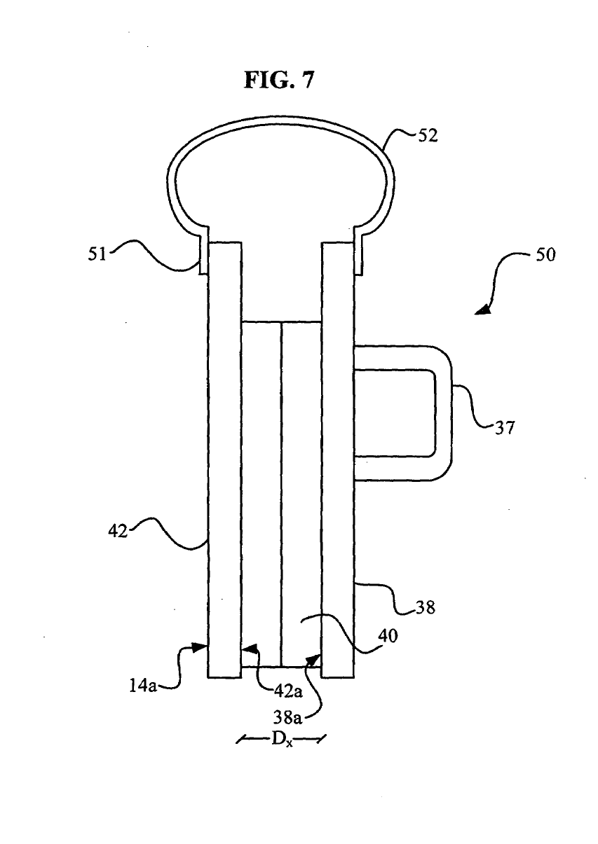

FIG. 7 shows a further embodiment system 50 according to the principles of the present invention. System 50 may include first elongated member 38 and second elongated member 42. First and second members 38 and 42 may be coupled to a spring steel 52 by a fastener 51. The distance Dx between members 38 and 42 may be varied by squeezing spring steel 52 to sandwich windshield 11 between them. First member 38 may include handle 37 for receiving a user's grip, and blade 40 that may be mounted on upper surface area 38a. Likewise second member 42 may include blade 44 that may be mounted on upper surface area 42a. Spring 52 may also be replaced by a variety of couplers or connectors, such wooden or steel clamp, and so forth.

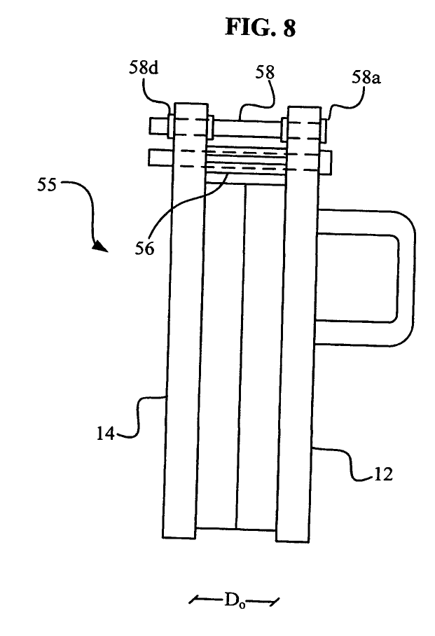

FIG. 8 shows an alternative embodiment system 55 according to the principles of the present invention. System 55 may include first elongated member 12 and second elongated member 14. Members 12 and 14 may be coupled by hexagonal shaped screw 56 to enable adjustment of the distance D0 between members 12 and 14. A user may tighten or loosen screw 56 by turning screw 56 clockwise or counterclockwise as desired to shorten or lengthen the distance between members 12 and 14 to enable sandwiching of windshield 11 between them. The hexagonal shape of screw 56 enables easy adjustments of the distance between members 12 and 14 without the need for any further mechanism. Screw 58 may permanently connect members 12 and 14.

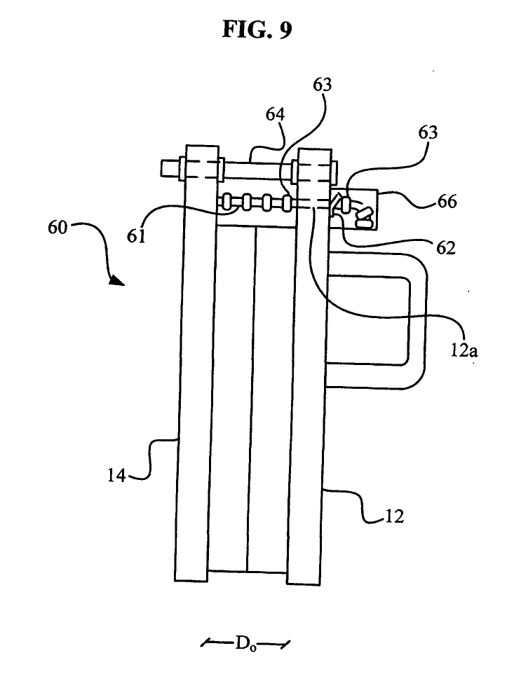

FIG. 9 shows an alternative embodiment system 60 according to the principles of the present invention. Members 12 and 14 may be coupled by a longitudinal member 61 carrying beads 63 between these members. Member 12 may include a passageway 12a to enable beads 63 to pass through into compartment 66. A user may vary the distance D0 between the members 12 and 14 by pulling beads 63 through passageway 12a into compartment 66. Compartment 66 may receive beads 63 and may include spring clip 62. Spring 62 urges against passageway 12a to prevent beads 63 from passing through passageway 12a in the opposite direction.

The invention also includes a method for wiping windshield 11. The method includes the steps of placing first elongated member 12 across inside surface 11a of windshield 11, placing a second elongated member 14 across outside surface 11b. Second member 14 may be coupled to first member 12, and first and second members 12 and 14 are separated by an initial distance D0. The method also includes the step of adjusting initial distance D0 between the members to sandwich windshield 11 between them.

We claim:

1. A system for wiping a windshield, the windshield being an arcuate and having an inside and outside surfaces, the system comprising:
a. a first elongated member for cleaning the inside surface, the first elongated member having an upper surface and a bottom surface,
b. a second elongated member for cleaning the outside surface, wherein the second elongated member is disposed opposite to the first member, wherein the second elongated member having an upper surface and a bottom surface, wherein the second member is coupled to the first member, and wherein the first and second members are moveable between a first position, where the first and second members are separated by an initial distance, and a second position, where the first and second members are separated by a final distance, to sandwich the windshield between them, and wherein the initial distance is different from the final distance.

2. The system of claim 1 wherein the first member comprises a handle mounted on the bottom surface for receiving a user's hand grip.

3. The system of claim 1 wherein the first member comprises a cleaning blade for cleaning the inside surface of the windshield, and wherein the blade is mounted on the upper surface of the first member, and wherein the second member comprises a cleaning blade for cleaning the outside surface of the windshield, and wherein the blade is mounted on the upper surface of the second member.

4. A system for wiping a windshield, the windshield being an arcuate and having an inside and outside surfaces, the system comprising:
a. a first elongated member for cleaning the inside surface, the first elongated member having an upper surface and a bottom surface,
b. a second elongated member for cleaning the outside surface, wherein the second elongated member is positioned opposite to the first member, wherein the second elongated member having an upper surface and a bottom surface, and
c. an adjustable fastener for attaching the first member to the second member, wherein the fastener is selectively adjustable to adjust the tension between the members and the windshield.

5. The system of claim 4 wherein the fastener comprises at least one adjustable screw for adjusting the tension between the members and the windshield.

6. The system of claim 4 wherein the first member comprises a handle mounted on the bottom surface for receiving a user's hand grip.

7. The system of claim 4 wherein the first member comprises a cleaning blade for cleaning the inside surface of the windshield, and wherein the blade is mounted on the upper surface of the first member, and wherein the second member comprises a cleaning blade for cleaning the outside surface of the windshield, and wherein the blade is mounted on the upper surface of the second member.

8. A system for wiping a windshield, the windshield being an arcuate and having an inside and outside surfaces, the system comprising:
a. a first elongated member for cleaning the inside surface, the first elongated member having an upper surface and a bottom surface, wherein the first member includes a cleaning blade for cleaning the inside surface of the windshield, wherein the blade is mounted on the upper surface of the first member, and wherein the first member includes a handle mounted on the bottom surface for receiving a user's hand grip,
b. a second elongated member for cleaning the outside surface, wherein the second elongated member is positioned opposite to the first member, wherein the second elongated member having an upper surface and a bottom surface, wherein the second member includes a cleaning blade for cleaning the outside surface of the windshield, and wherein the blade is mounted on the upper surface of the second member, and
c. an adjustable fastener for attaching the first member to the second member, wherein the fastener is selectively adjustable to adjust the tension between the members and the windshield.

9. A method for wiping a windshield, the windshield being an arcuate and having an inside and outside surfaces, the method comprising the steps of:
a. placing a first elongated member across the inside surface, the first elongated member having an upper surface and a bottom surface,
b. placing a second elongated member across the outside surface, wherein the second elongated member is disposed opposite to the first member, wherein the second elongated member having an upper surface and a bottom surface, wherein the second member is coupled to the first member, where the first and second members are separated by an initial distance, and
c. adjusting the initial distance between the first and second members to sandwich the windshield between them.

10. The method of claim 9 wherein the first member comprises a cleaning blade for cleaning the inside surface of the windshield, and wherein the blade is mounted on the upper surface of the first member, and wherein the second member comprises a cleaning blade for cleaning the outside surface of the windshield, and wherein the blade is mounted on the upper surface of the second member.

11. The method of claim 10 wherein the first member further includes a handle mounted on the bottom surface for receiving a user's hand grip.

12. The method of claim 11 further including the step of using the handle to move the first and second members across the inside and outside surfaces to wipe the windshield.

13. A system for wiping a windshield, the windshield being an arcuate and having an inside and outside surfaces, the system comprising:
a. means for wiping the outside surface of the windshield,
b. means for wiping the inside surface of the windshield, and
c. means for adjusting the distance between the means for wiping the outside surface and the means for wiping the inside surface to sandwich the windshield between them.
